(19) United States
(12) Patent Application Publication
(10) Pub. No.: US 2002/0181059 A1
(43) Pub. Date: Dec. 5, 2002

(54) Broadband communication for satellite-ground or air-ground links

(76) Inventor: Paul F. Christopher, Leesburg, VA (US)

Correspondence Address: ARNOLD & PORTER, IP DOCKETING DEPARTMENT; RM 1126(b), 555 12TH STREET, N.W., WASHINGTON, DC, 20004-1206, US

(21) Appl. No.: 09/986,057

(22) Filed: Nov. 7, 2001

Related U.S. Application Data
(60) Provisional application No. 60/246,643, filed on Nov. 7, 2000.

(51) Int. Cl. H04B 10/00

(52) U.S. Cl. 359/172

(57) ABSTRACT

The present invention provides a system and method for satellite and terrestrial base station communications utilizing an infrared signal. The optimal location for the present invention is determined based on the frequency, and derived attenuation, of the infrared signal. Attenuation is also based on the cloud water content persistent at any determined optimal location, where cloud water content may be determined by varying an exceedance probability. The satellite of the present invention may be part of a combined system of satellites in Molniya elliptical orbits and geosynchronous orbits.

### RELATED APPLICATION

The present invention claims priority to a U.S. provisional application filed on Nov. 7, 2000 by the present inventor, which is hereby incorporated by reference.

### FIELD OF THE INVENTION

The present invention relates to a satellite communications system utilizing orbiting communications satellites and reception/transmission stations. In particular, the system utilizes high frequency bands in the infrared region for communication with the reception/transmission stations to reduce reception and/or transmission signal attenuation. In addition, the system utilizes a combined satellite array of satellites placed in geosynchronous orbits and satellites placed in elliptical, “Molniya” type orbits.

### BACKGROUND

Traditional communications satellites of the type known in the art occupy an orbit in which the satellite orbits a celestial body with the same angular velocity as that body's internal rotation. When the orbit is placed of the equator of that celestial body, these types of satellites are known as geosynchronous satellites, and the orbits they occupy are known as geosynchronous orbits. For the Earth, geosynchronous orbit occurs at 22,237 miles above the Earth (or approximately 36,000 kilometers), and the orbit path above the Earth circumscribes a circle. (Although all future references referring to satellites and orbits will be utilized in the context of a satellite system orbiting the Earth, it will be recognized that the concepts could apply to any satellite/celestial body system.)

Because geosynchronous satellites have the same angular velocity as Earth's rotation, these satellites appear to be fixed relative to a point on the Earth. This feature facilitates communications between the satellite and Earth, as it is possible to fix the reception and transmission apparatus of ground stations to be directed constantly at the satellite. Today numerous communications systems employ geosynchronous satellites for applications such as telephone and data communications, television signal distribution, direct-to-home data broadcasting, and mobile communications. The fact that geosynchronous satellites are stationary over a point relative to the Earth facilitates their use for communication applications; a reception/transmission station on Earth can communicate with the satellite by directing their antennas at essentially one position in the sky.

For a geosynchronous system, in which the satellites are in orbit above the equator, reception/transmission ground stations in the equatorial regions generally communicate with the satellites at high elevation angles above the horizon. However, as the latitude of an earth station located on increases, the elevation angle to geosynchronous satellites from the reception/transmission ground station decreases. For example, elevation angles from ground stations in the United States to geosynchronous satellites range from 20 to 50 degrees.

Low elevation angles can degrade the satellite communications link in several ways. The significant increase in path length through the atmosphere at low elevation angles exacerbates such effects as rain fading, atmospheric absorption and scintillation. For mobile communications systems in particular, low elevation angles increase link degradation due to blockage and multi-path effect.

To overcome these deficiencies, various non-geosynchronous satellite systems have been implemented. Starting in the 1960's, communications satellites were placed in elliptical orbits over the Earth. An elliptical orbit satellite differs from a geosynchronous satellite because it does not remain at a constant altitude above the Earth, but instead operates at a varying altitude within the limits of the orbits perigee and apogee.

Elliptical orbit satellites spend the majority of their time in orbit near their apogee, or point farthest away from the Earth. Conversely, these types of satellites spend a minimal amount of time near their perigee, or point closest to the Earth. For example, an elliptical orbit satellite with a twelve-hour orbit spends approximately eight hours of that orbit time near its apogee.

One type of elliptical orbit is known as the Molniya orbit. In the 1960s a communications satellite known as the Molniya was placed in a twelve-hour elliptical orbit by the former Soviet Union. A typical Molniya orbit lingers over Russia for approximately eight hours per day. By positioning satellites in sequence in the same elliptical orbit, as little as three satellites would be able to provide coverage for the Russian landmass. All Molniya orbits have orbital inclinations of approximately 63 degrees, in order to reduce or eliminate rotation of the line of apsides—the major axis of the ellipse—due to gravitational perturbations. Russian satellites utilizing Molniya orbits have arguments of perigee at or near two-hundred-seventy degrees to bias coverage over the Northern Hemisphere of the Earth. These types of orbits have been copied by other satellite systems, such that the positioning of satellites in various hourly orbit configurations, with various orbital inclinations, allows coverage over pre-selected landmasses.

Other elliptical orbit satellite systems have recently been considered. For example, satellites occupying APTS orbits have an elliptical orbit wherein the apogee is always pointing towards the sun, thereby increasing daytime coverage capacity. A hybrid system is known as the Gear Array, invented by John E. Draim of Space Resource of America, which combines satellites occupying an APTS orbit with satellites occupying a geosynchronous orbit. Another hybrid system, known as Ellipso, combines the features of satellites occupying a Molniya orbit with satellites occupying a geosynchronous orbit. The Ellipso system is designed to provide continuous coverage from the North Pole to 55 degrees South latitude. In this system, two planes of leaning, elliptical sun-synchronous orbits are utilized, with orbital periods of approximately three hours and apogee altitudes of approximately 7846 kilometers. These two inclined orbital planes remain edge-on to the sun year round, with the apogees slightly favoring the sunlit hemisphere. A third plane uses a circular equatorial orbits at 8040 kilometers altitude to give tropical and Southern hemisphere coverage.

The major advantage offered by placing satellites in elliptical orbits is the ability to increase the elevation angles offered for satellite communications to and from ground stations that are not located along the equator. The decrease in signal attenuation made such communications highly effective, especially when the capability was introduced of “passing-off” the signal from one satellite to another as they entered the portions of their orbit farthest away from the Earth.

These prior art satellite systems utilized high frequency communication bands in the electromagnetic spectrum to offer effective communications between the satellites and ground stations. In particular, frequencies ranging from 12 to 14 GHz were common for these satellites, as they were deemed the most effective frequencies to offer reliable communications with acceptable signal attenuation. Satellite communications are highly dependent on signal attenuation—the amount of signal loss associated with the selected communication path. Signal attenuation for any given satellite communication system depends on at least two factors: 1) the general atmospheric condition of any given location; and 2) the atmospheric path length at which a signal must travel between satellite and reception/transmission station. Prior satellite communication frequencies have operated at frequency bands lower, or now, within the region of the Ku band due to the signal attenuation present at normal operating positions for satellites. For example, most prior art satellite systems utilize three bands within the frequency spectrum: the C band (fixed service satellite) (ranging from roughly 3 to 7 GHz); the Ku band (fixed service satellite) (ranging from 11 to 14 GHz); and the direct broadcast service (DBS) spectrum allocation within the Ku band (ranging from 12 to 17 GHz). These wavelengths correlate to frequencies in the range of 5.06-8.11 cm (C band), 2.07-2.56 cm (Ku band), and 1.68 to 2.46 cm (DBS operations within the Ku band).

Current research and development systems also attempt to utilize satellite communications systems with optical communication systems in the range of one micron wavelengths. For example, studies at the Jet Propulsion Laboratory utilize ground stations at high earth elevations and laser communication techniques. These systems, however, have limited effectiveness because they have been tested only at desert and high-earth altitude sites, specifically chosen for low atmospheric signal loss characteristics. In addition, these systems offer shortcomings in that cloud attenuation is fatal for effective laser satellite communication systems, and because the coverage offered by such systems is limited and only covers selected areas of the Earth, many of which are not populated and therefore ill suited to take advantage of satellite communications.

Another factor limiting satellite communications is the limited number of orbital slots. Both international bodies and the Federal Communications Commission regulate the locations of satellites within orbits where operations can occur. These locations, specified in degrees of longitude, are known as “orbital slots.” Orbital slots are necessarily limited due to the potential for signal interference between satellites. As prior art satellites all communicate with ground stations within closely-related frequency bands, the spacing of such satellites (i.e., the spacing between orbital slots) must be sufficient so that signal interference between adjacent satellites is minimized. Governmental entities have regulated orbital slots at a minimum of 2 degrees longitude; i.e., satellites must be spaced at least 2 degrees longitude from an adjacent satellite to avoid signal degradation and orbital overlap.

### BRIEF DESCRIPTION OF THE INVENTION

The present invention is a satellite communication system having a satellite communicating with the terrestrial base station using an infrared signal, where the optimal location for transmitting or receiving the infrared signal is determined based on a frequency of the infrared signal and the attenuation of the infrared signal. The optimal location can be determined based on attenuation and desired frequency, and communication encompasses both transmission and/or reception.

The satellite communication system of the present invention also includes a system whereby the attenuation is based on the cloud water content persistent in a region including the optimal location.

The satellite communication system of the present invention also includes a system whereby the optimal location is defined by longitude and latitude.

The satellite communication system of the present invention also includes a system whereby the cloud water content is determined based on an exceedance probability, or based on a cloud water content formula.

The satellite communication system of the present invention also includes a system whereby the optimal location is based on the probability density function of an elevation angle.

The satellite communication system of the present invention also includes a system whereby a second satellite, a third satellite, a fourth satellite, and a fifth satellite are included, with the first, second, and third satellites each being in a phased Molniya orbit, and the fourth and fifth satellites each being in a geosynchronous orbit.

The present invention is also a terrestrial base station communication system having a satellite communicating with the terrestrial base station using an infrared signal, where the optimal location for transmitting or receiving the infrared signal is determined based on a frequency of the infrared signal and the attenuation of the infrared signal. The optimal location can be determined based on attenuation and desired frequency, and communication encompasses both transmission and/or reception.

The terrestrial base station communication system of the present invention also includes a system whereby the attenuation is based on the cloud water content persistent in a region including the optimal location.

The terrestrial base station communication system of the present invention also includes a system whereby the optimal location is defined by longitude and latitude.

The terrestrial base station communication system of the present invention also includes a system whereby the cloud water content is determined based on an exceedance probability, or based on a cloud water content formula.

The terrestrial base station communication system of the present invention also includes a system whereby the optimal location is based on the probability density function of an elevation angle.

The terrestrial base station communication system of the present invention also includes a system whereby a second satellite, a third satellite, a fourth satellite, and a fifth satellite are included, with the first, second, and third satellites each being in a phased Molniya orbit, and the fourth and fifth satellites each being in a geosynchronous orbit.

### BRIEF DESCRIPTION OF THE DRAWINGS

FIG. 1 is a chart representing signal attenuation at various frequencies for ground fog and rain.

FIG. 2 is a chart representing signal attenuation at 22.2 GHz for various locations at a zenith path.

FIG. 3 is a chart representing signal attenuation at 49.5 GHz for various locations at a zenith path.

FIG. 4 is an equation calculating signal attenuation at any frequency for various locations at a zenith path.

FIG. 5 is a chart representing cloud attenuation at 22.2 GHz for various locations at a zenith path.

FIG. 6 is a chart representing cloud water content for various locations at a zenith path and 99% “non-rainy” conditions.

FIG. 7 is an equation calculating cloud water content at a zenith path, given a location (in latitude and longitude, degrees) and an exceedance probability.

FIG. 8 is a chart representing cloud attenuation at the infrared wavelength of 10 microns, with a 99% “non-rainy” condition.

FIG. 9 is a chart representing cloud water content for various locations, at a zenith path and 90% “non-rainy” conditions.

FIG. 10 is a chart representing cloud attenuation at the infrared wavelength of 10 microns, with a 90% “non-rainy” condition.

FIG. 11 is a chart representing cloud attenuation at 10 micron wavelengths, with 10% exceedance, for various Earth locations at six selected attenuation levels.

FIG. 12 is a chart representing cloud attenuation at 1 micron wavelengths, with 10% exceedance, for various Earth locations at six selected attenuation levels.

FIG. 13 is a chart representing cloud water content for various locations at a zenith path and 80% “non-rainy” conditions.

FIG. 14 is a chart representing cloud attenuation at the infrared wavelength of 10 microns, with a 80% “non-rainy” condition.

FIG. 15 is a chart representing cloud attenuation at 10 micron wavelengths, with 20% exceedance, for various Earth locations at six selected attenuation levels.

FIG. 16 is a chart representing cloud attenuation at 1 micron wavelengths, with 20% exceedance, for various Earth locations at six selected attenuation levels.

FIG. 17 is a representation of a satellite in a Molniya orbit at one-hour intervals.

FIG. 18 is a representation of three satellites in phased Molniya orbits for high elevation angles in the Northern Hemisphere.

FIG. 19 is an equation showing a probability density function (pdf) as a function of latitude for a combined satellite configuration of Molniya and geosynchronous orbits according to the present invention, were x represents elevation angle in degrees.

FIG. 20 is a representation of a combined Molniya-geosynchronous satellite system.

FIG. 21 is a chart representing the pdf of various ground sites communicating with a satellite system according to the present invention.

FIG. 22 is a chart representing optimal frequency for a satellite configuration of Molniya and geosynchronous orbits according to the present invention.

FIG. 23 is a representation of a high data rate communication link.

FIG. 24 is a representation of a high data communication link.

### DETAILED DESCRIPTION OF THE INVENTION

The present invention addresses the problems of the prior art by providing a method for satellite communication, using the infrared portion of the electromagnetic spectrum, that results in low signal attenuation. The satellite system of the present invention combines various satellite orbit configurations, and offers a satellite system that offers coverage (i.e., signal availability) to common areas in the Northern Hemisphere. The present invention realizes the benefits of optical communication systems at available frequencies in the electromagnetic spectrum with signal loss reduced to a level that allows effective communications.

The present invention overcomes the deficiencies in the prior art by utilizing satellites combined in geosynchronous and elliptical orbits with infrared communication systems. In one aspect of the invention, the orbits of the system of satellites are such that signal attenuation is minimized and effective signal coverage is provided to populated regions of the Earth. In a further aspect of the present invention, the attenuation associated with communications between satellites of the present invention ground stations is optimized by utilizing infrared communications systems.

The present invention offers an increased frequency spectrum available for satellite communications, with low signal attenuation, that is not subjected to government regulated orbital slots. The present invention combines the advantages of communications equipment in the infrared region, low signal attenuation, and a wide operating capability not present in satellite systems of the prior art.

The present invention combines the spectrum advantages of optical systems with the low attenuation features of radio frequency systems. The communications system of the present invention utilizes the infrared band, which offers relatively low signal attenuation through moisture environments, and retains the wide bandwidth available to optical systems over radio frequency systems.

The present invention offers a lower signal attenuation in clouds than typical ground laser communication systems, and offers a wider range of ground stations other than those present at high earth elevations. In addition, when compared to satellite systems known in the prior art, the present invention offers the advantage have having no frequency conversions (just as optical systems would require no frequency conversions). In contrast, satellite communication systems of the prior art almost universally require frequency conversions somewhere on the ground-air-ground links. The use of optical signal processing techniques on the satellites of the present invention results in having no radio frequency to optical conversions required. This feature the inexpensive, fast processing and switching on the orbiting communications vehicle. These simple, fast switching techniques would be in sharp contrast to the slow, cumbersome, and expensive electronic switching on the NASA ACTS 30 GHz satellite. In addition, the system of the present invention offers an increased signal spectrum availability, with more than 1000 times the available spectrum available in existing systems. Spectrum availability is a prime consideration for internet development, as bandwidth requirements have been estimated as doubling every 2 to 3 months. Finally, the satellite system of the present invention does not require adherence to government regulations for orbital slots, and only requires minimal adherence to government regulations on the use of the contemplated frequency spectrum.

Satellite orbit and communication characteristics utilize the following nomenclature, all of which is known in the art and all of which may be applied to any orbit configuration. “Attenuation” is the amount of power lost in electromagnetic signals between the transmission and reception points. The “elevation angle” of a communications system is the angle from a reference point on Earth up to the satellite. Thus, a satellite directly overhead the reference point would have an elevation angle of ninety degrees, while a satellite at the horizon relative to the reference point would have an elevation angle of zero degrees.

The present invention overcomes limitations in the prior art satellite communications systems resulting from signal attenuation. Satellite communications are most affected by the moisture content in the atmosphere, especially present in cloud formations. Satellites utilizing communications in the C Band frequencies have little or no attenuation related to moisture content. However, these systems, in addition to only being available on certain satellite systems, possess the disadvantages associated with low frequency communications, especially the amount of and size of the equipment required for effective ground-satellite communications. Satellites utilizing communications in the Ku Band frequencies and subject to high degradation, and thus high signal attenuation, in conditions with high atmospheric moisture content. This attenuation makes effective communication more difficult, for example, in tropical areas or other areas of high atmospheric moisture content.

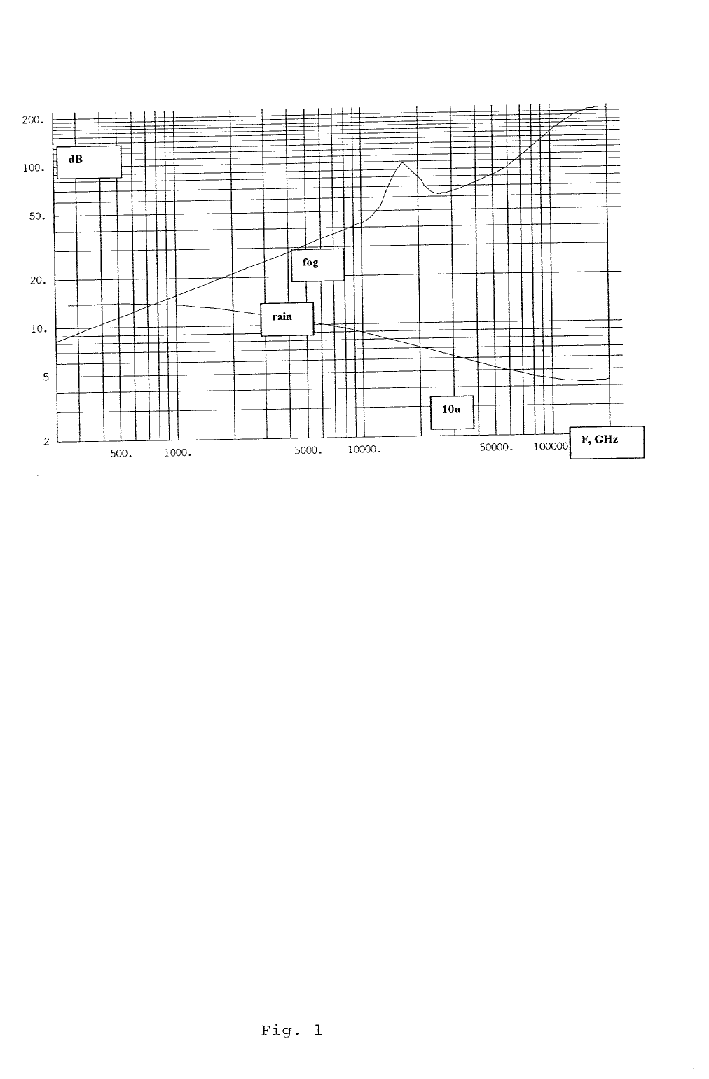

The present invention utilizes calculations for cloud signal attenuation first studied in the prior art by Chu and Hogg. In these studies, Chu and Hogg derived attenuation values for optical and infrared communications (in the 10.6 micron wavelength). Their studies showed that infrared signals propagated better through fog than optical signals. FIG. 1 is a chart derived from the data of Chu and Hogg, showing signal loss (in dB) through 1 km of fog with 0.1 gm/m³ liquid water density through various frequencies. As shown in FIG. 1, where 10 microns correlates to 30 THz frequency and 1 micron correlates to 300 THz frequency, for fog conditions the attenuation results in approximately 60 dB signal loss at 10 microns, and 200 dB signal loss at 1 micron wavelengths.

The Chu and Hogg studies were for terrestrial communications, not satellite communications. It is impossible to derive cloud moisture content values (and thereby calculate signal attenuation) for satellite communications, as opposed to ground fog or rain. Because the total water content for clouds was not known from these studies, it was presumed that the high water content present in clouds would make neither optical (near 1 micron wavelength) nor infrared (near 10 micron wavelength) communications possible. As a result, satellite communications systems remained in the mid level to high frequency bands.

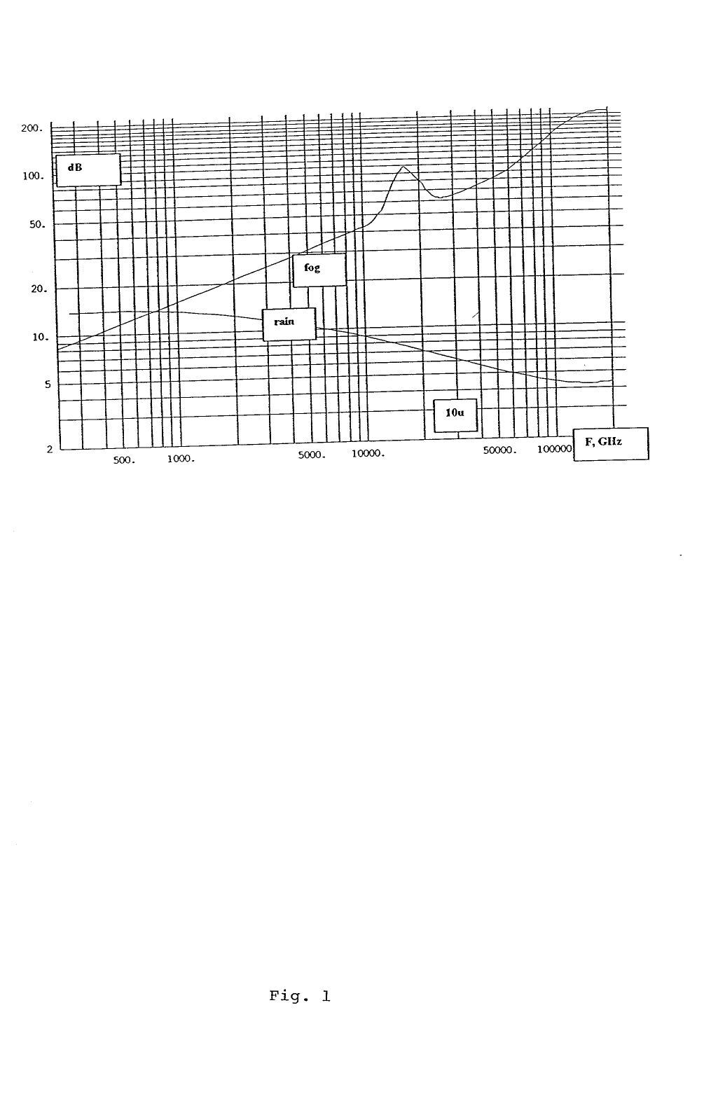

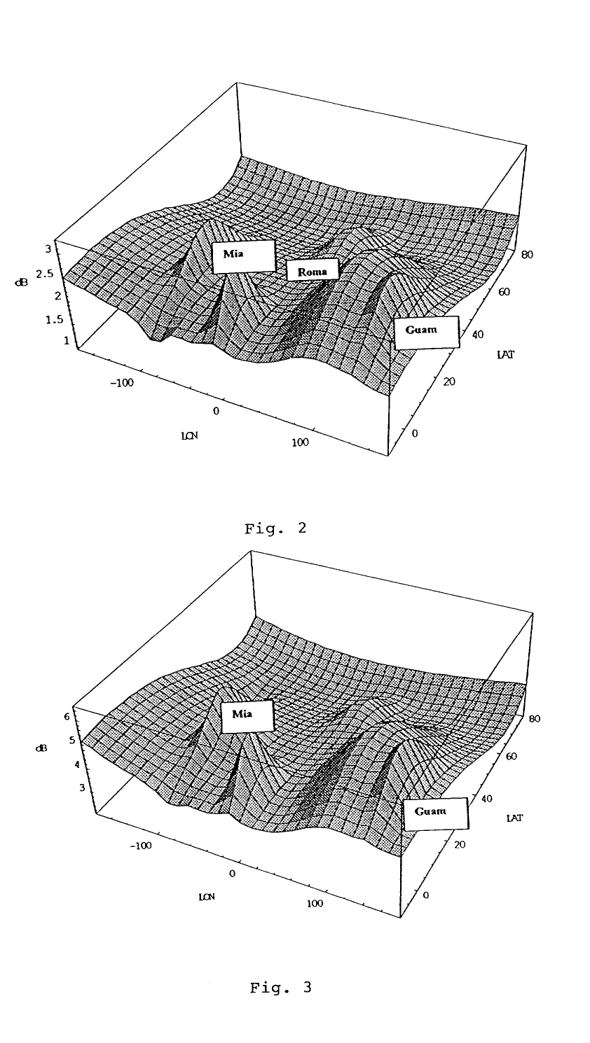

An embodiment of the present invention utilizes formulations for cloud water content. This formulation is derived from the prior art of Chu and Hogg, described above, and prior art investigated by F. Barbaliscia et al. This latter prior art calculates signal attenuation values for very small aperture satellite systems with an assumption of 99% “non-rainy” atmospheric conditions, which is the condition just prior to the commencement of rain. In particular, zenith attenuation maps for selected portions of Europe and other regions, with 99% “non-rainy” conditions, exist in the prior art, demonstrated by F. Barbaliscia, M. Boumis, and A Martellucci, “World Wide Maps of Non Rainy Attenuation for Low Margin Satcom Systems Operating in the SHF/EHF Bands,” Ka Band Conference, September 1998. FIG. 2 shows the graph produced by Barbaliscia et al. showing attenuation at the frequency 22.2 GHz, while FIG. 3 shows the graph produced by Barbaliscia et al. showing attenuation at the frequency 49.5 GHz. The results shown in FIGS. 2 and 3 were for satellites assumed to be at the “zenith” position, i.e. directly overhead any given point with an elevation angle of 90 degrees.

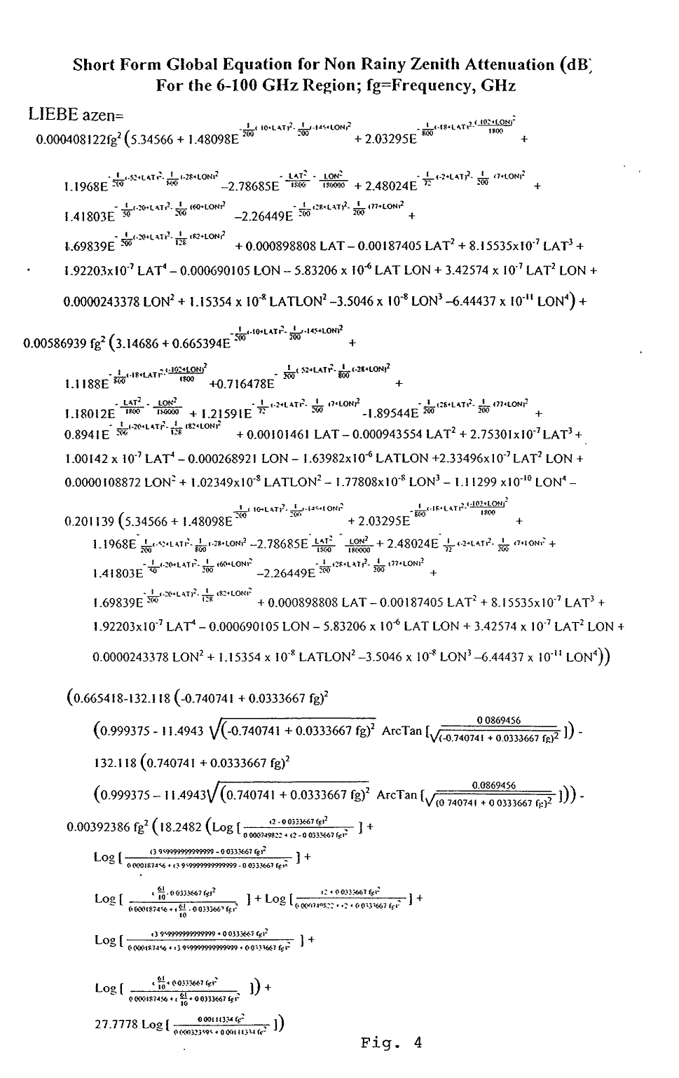

These attenuation graphs of the prior art do not present a meaningful manner in which to relate signal attenuation to clouds, apart from any atmospheric moisture effects. The representation of attenuation shown in FIG. 1, at 22.2 GHz, largely relates to water vapor absorption as the primary atmospheric condition. The representation of attenuation shown in FIG. 2, at 49.5 GHz, relates to oxygen, cloud, and water vapor absorption as the atmospheric conditions. These maps (shown in FIGS. 1 and 2) can be approximately solved for water vapor and cloud attenuation. After the effects of clouds and water vapor and separated, zenith attenuation was estimated over a wide range of frequencies with integrated gaseous attenuation models. Calculation of zenith attenuation functions was derived by the present inventor using liebe's water vapor relations. Thus, from these two attenuation graphs, the inventor of the present invention derived a general attenuation function for a wide range of frequencies (again, with 99% “non-rainy” conditions); this function and results for the range up to 100 GHz were derived and described in P. Christopher, “World Wide Millimeter Wave Attenuation Functions from Barbaliscia's 49/22 GHz Observations,” Ka Band Conference, Toarmina Sicily, October 1999, attached hereto as an Appendix. In this work an equation derived from the work in the prior art which calculates such attenuation (in dB) is shown in FIG. 4, where fg is frequency, in GHz, and assuming “non-rainy” zenith attenuation.

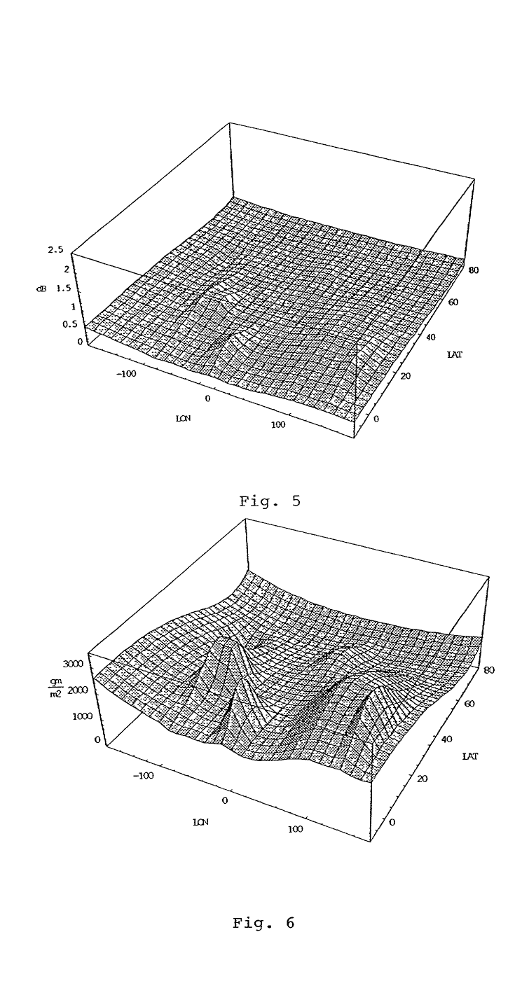

To derive the total water content of the clouds themselves, the present invention applies the formula in FIG. 4 to the earlier prior art work to determine the net effects of cloud attenuation at 22.2 GHz. Thus, the values shown in FIGS. 2 and 3 can be manipulated to separate the attenuation effects of the clouds themselves from the water vapor present in those clouds. As shown in FIG. 5, the affect of attenuation for clouds themselves (which results in a 1% “non-rainy” condition) at 22.2 GHz can be represented.

The present invention utilizes a satellite system that can combine the works in the prior art to derive the water content of clouds at 99% “non-rainy” conditions. As shown in FIG. 6, the total water content (in gm/m²) of clouds can be shown for variable locations on the Earth, again assuming a zenith position (i.e., from a ground antenna pointed at zenith, or 90 degrees elevation angle). These values can be calculated for 10 micron wavelengths—combining the works of Chu and Hogg with Barbaliscia et al. results in FIG. 6, which shows 10 micron wavelength cloud attenuation at 99% “non-rainy” conditions.

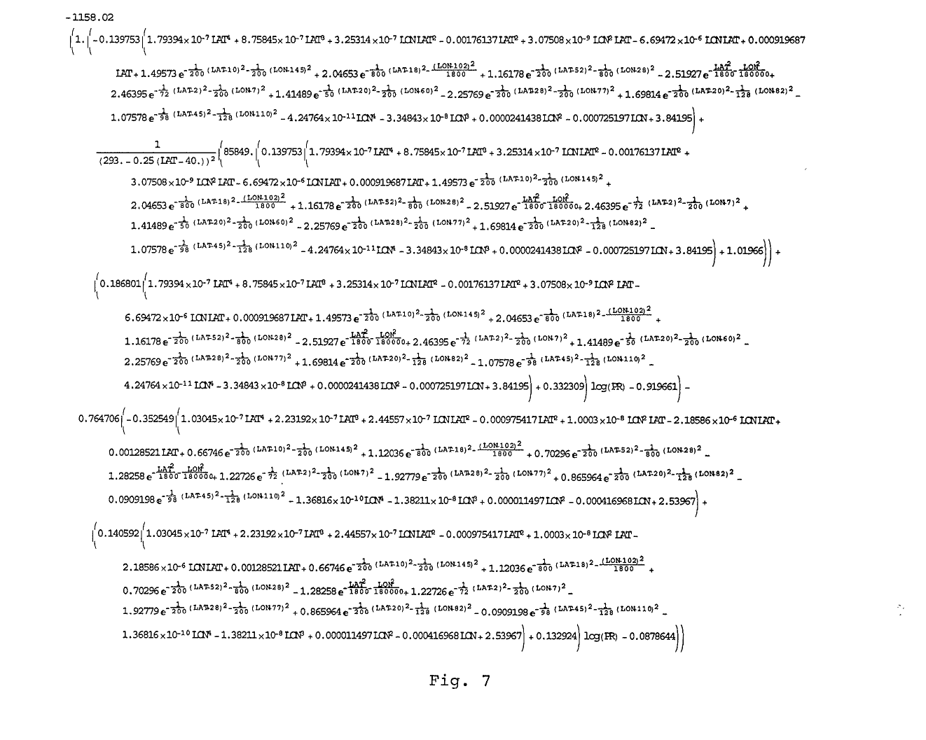

The present invention utilizes a method to calculate cloud cover attenuation derived from the above-indicated prior art for infrared communication frequencies. This method calculates the cloud water content (in g/m²) for a zenith communications link according to the following (where PR=exceedance probability, and LON and LAT are earth locations in longitude and latitude (degrees) respectively), and is shown in FIG. 7.

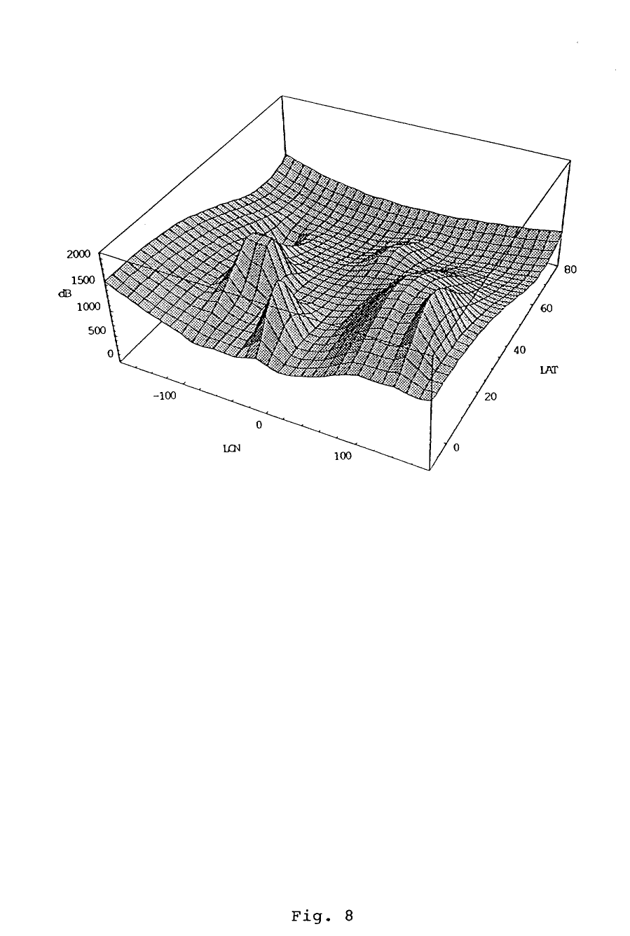

The present invention utilizes these calculations to determine signal attenuation in the infrared region. The prior art of Barbaliscia et al. determined attenuation for various conditions at certain frequencies in the GHz range; from that prior art (and utilizing a general attenuation function), cloud attenuation can be determined (as opposed to attenuation from other atmospheric conditions); applying the formula for cloud water content determines such values at certain conditions (informed from the prior art of Chu and Hogg with Barbaliscia et al.); and applying the values for cloud attenuation (in dB) with the values for water content (in g/m²), with the work of Chu and Hogg, yields cloud attenuation at the infrared region. As shown in FIG. 8, the cloud attenuation for the 10 micron wavelength region has been calculated: the water content of the clouds (in gm/m2) at a location is multiplied using the 10 micron values for “fog” in FIG. 1 (derived from work in the prior art, where fog is assumed to be equivalent to cloud cover) (where the values are for attenuation for atmospheric conditions in g/m³ per km of pathlength). In this manner the attenuation for an infrared region can be determined according to the present invention.

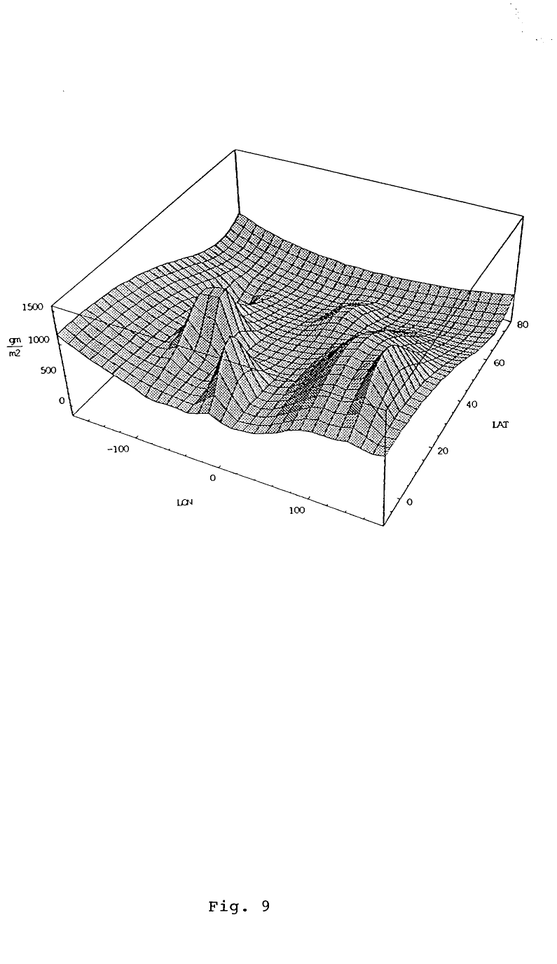

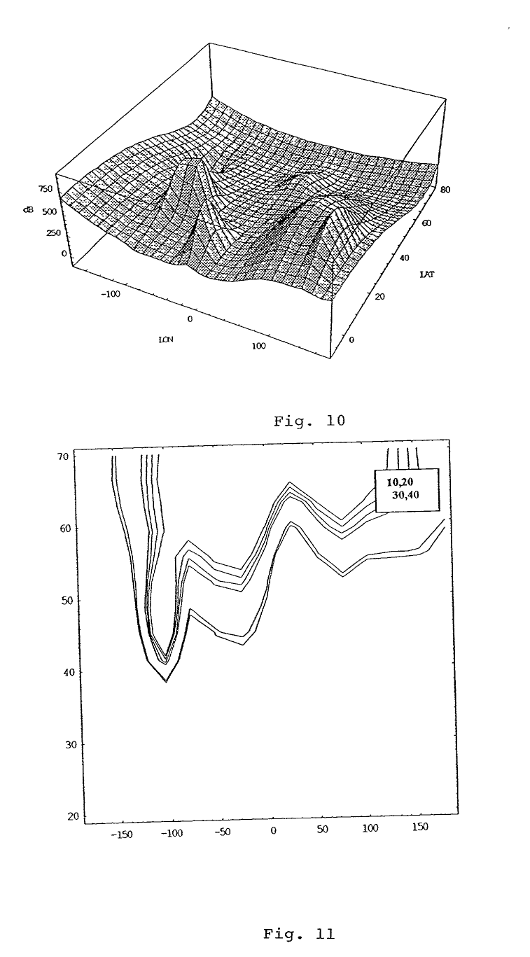

From this equation it is possible to derive cloud water content at exceedance probabilities greater than the 1% value (99% “non-rainy) utilized in the prior art. For example, at 10% exceedance (90% “non-rainy”), the cloud water content for various locations are less severe than for the previously derived 1% exceedance value, as shown in FIG. 9. Attenuation for a 10 micron infrared communication with 10% exceedance is shown in FIG. 10.

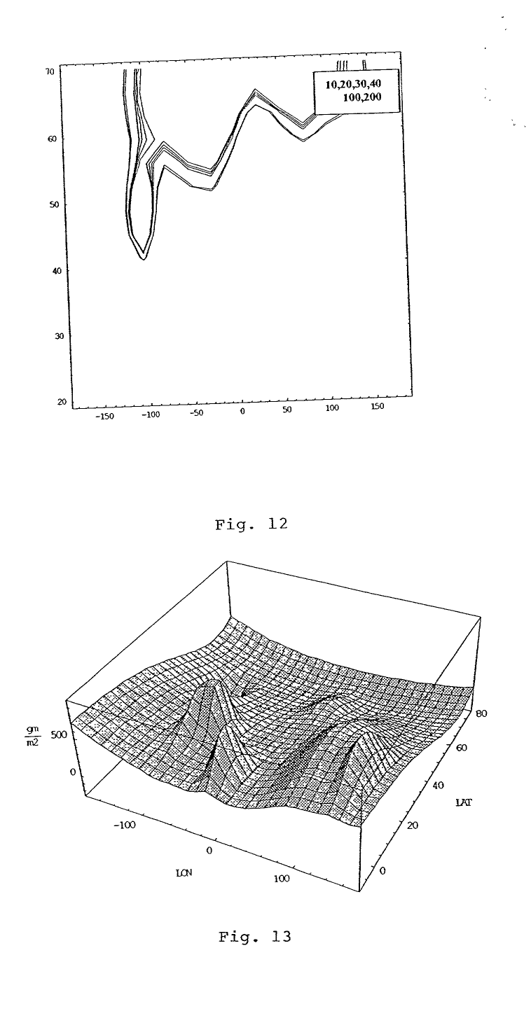

FIG. 11 graphs attenuation at 10 micron wavelength communications, with 10% exceedance, for various Earth locations at six selected attenuation levels (latitude is charted on the y axis, longitude on the x axis, with the contours showing attenuation at 10, 20, 30, 40, 100, and 110 dB). FIG. 12 graphs similar attenuation contours at 1 micron wavelength communications.

From this equation, it is also possible to derive cloud water content at 20% exceedance (80% “non-rainy”). As shown in FIG. 13, the cloud water content for various locations are less severe than for the previously derived 1% and 10% exceedance value. Similarly, attenuation for a 10 micron infrared communication with 20% exceedance is shown in FIG. 14.

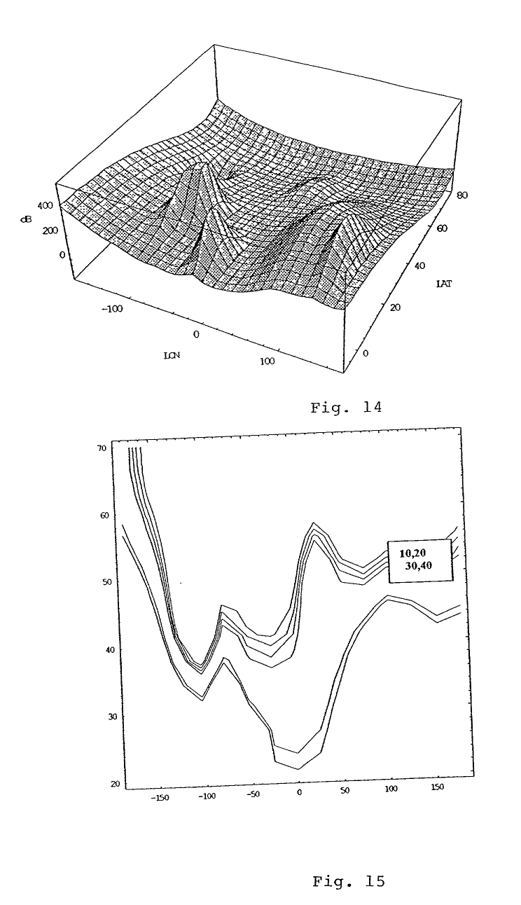

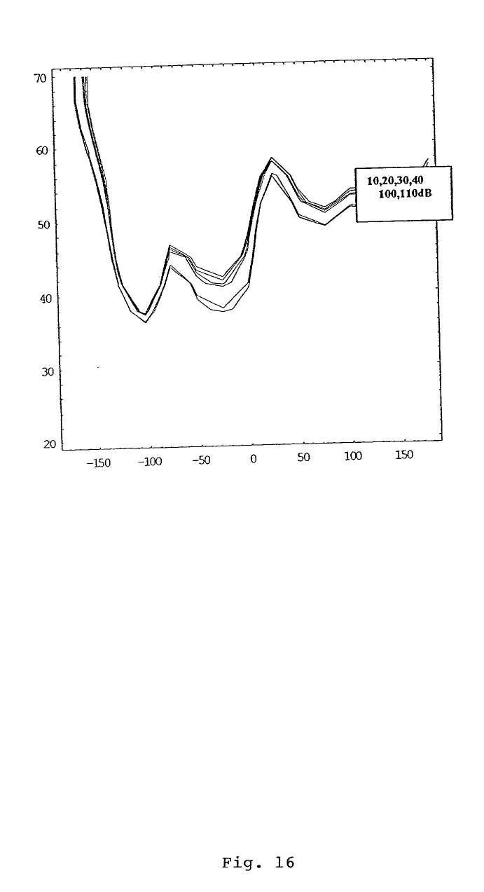

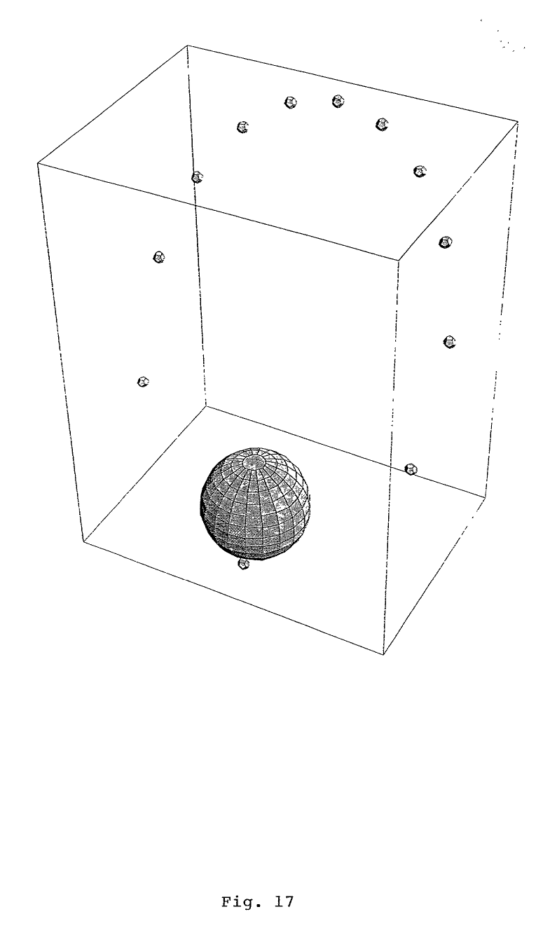

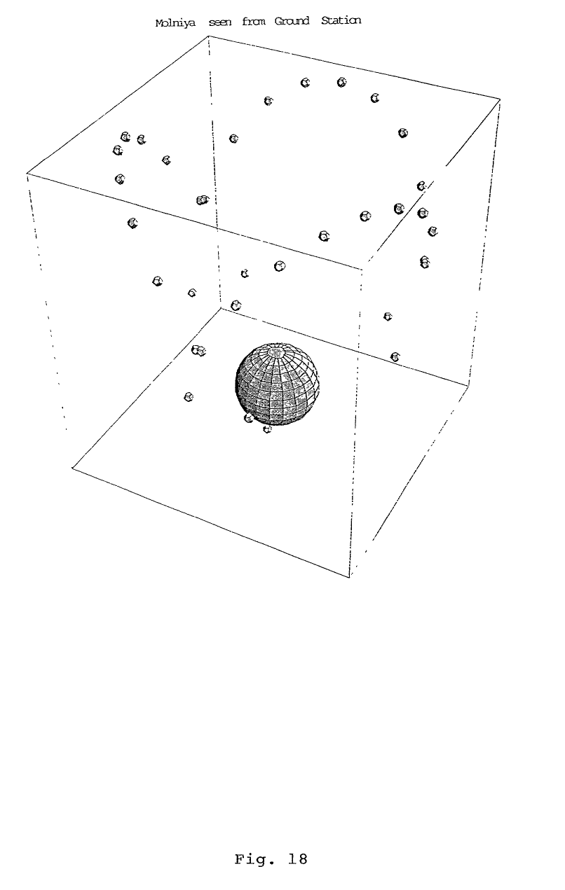

FIG. 15 graphs attenuation at 10 micron wavelength communications, with 20% exceedance, for various Earth locations at six selected attenuation levels (latitude is charted on the y axis, longitude on the x axis, with the contours showing attenuation at 10, 20, 30, 40, 100, and 110 dB). FIG. 16 graphs similar attenuation contours at 1 micron wavelength communications.

Thus, the present invention calculates attenuation for cloud conditions at any given location, and is especially suited for determining attenuation for frequencies in the infrared region. Of course, the methods whereby satellite transmission and reception may occur with infrared communication devices is well known in the art and will not be described here, but any such system providing infrared communications is applicable to the present invention.

The above methods, when utilized in a satellite communications system, indicate attenuation values at the zenith path. Thus, the above calculations show the attenuation values that exist for worldwide cloud content when looking at a 90 degree elevation angle. This assumption ignores the signal loss present from variable elevation angles, where the signal path increases through the atmosphere. For example, geosynchronous satellites of the type known in the prior art have low elevation angles to the most populous regions (i.e., a low elevation angle exists from ground stations in the Northern Hemisphere, including the continental United States, to a geosynchronous satellite). As a result, utilizing a geosynchronous satellite for communication would result in higher attenuation values due to the elevation angle and longer atmospheric signal paths. In contrast to geosynchronous satellites, Molniya satellites operate in elliptical orbits similar to that shown in FIG. 17, which shows a Molniya orbit at one hour intervals, with i=63.425 deg. and e=0.725. As shown in FIG. 17, while the satellite is at its perigee it occupies a location over the Northern Hemisphere of the Earth for up to eight hours. In addition, its location is at or near the zenith (i.e., 90 degree) elevation angle. Effective continuous communication in the Northern Hemisphere is easily provided by a system of three satellites in Molniya orbits, as shown in FIG. 18.

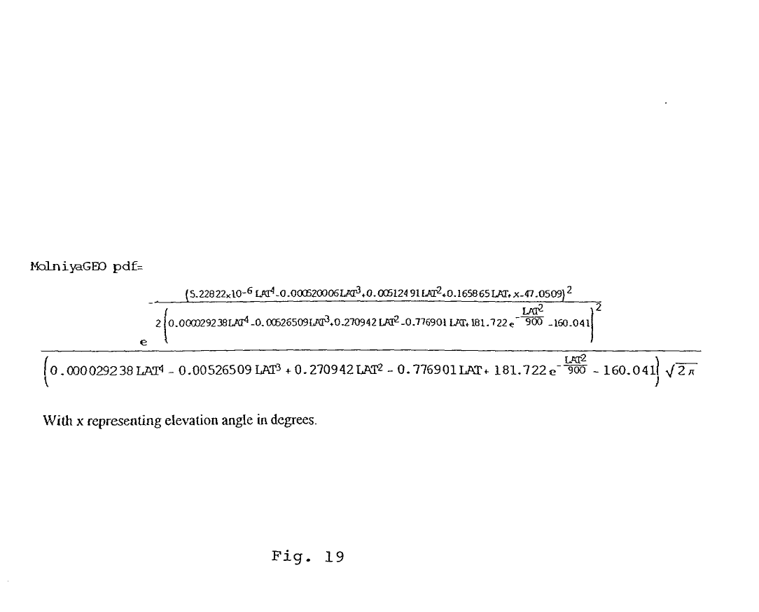

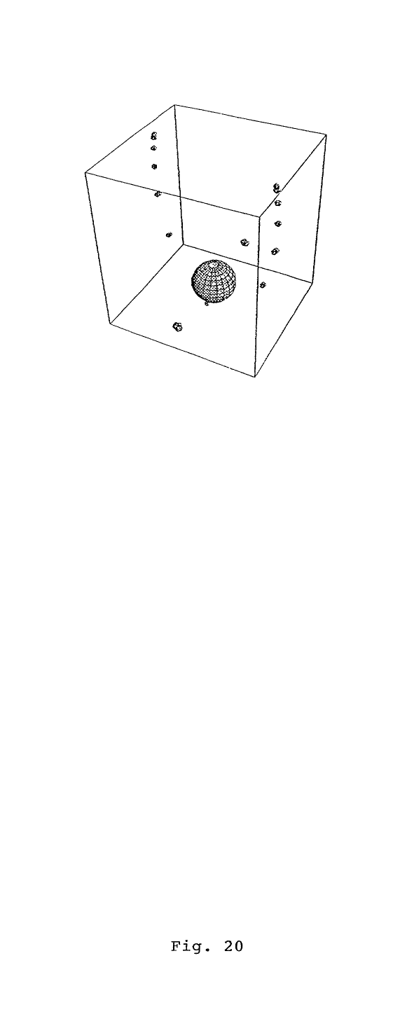

The attenuation values for varying atmospheric path lengths may be calculated by applying the cosecant to the elevation to modify the zenith attenuation factors for expected satellite positions in actual constellations. The resulting elevation probability density function (pdf) as a function of latitude can be calculated for Molniya satellites according to the equation shown in FIG. 19, where x represents the elevation angle (in degrees) and LAT represents latitude.

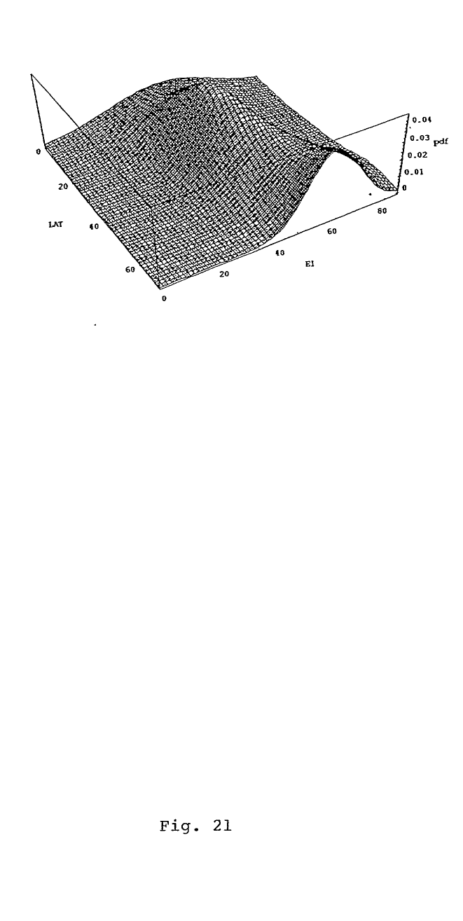

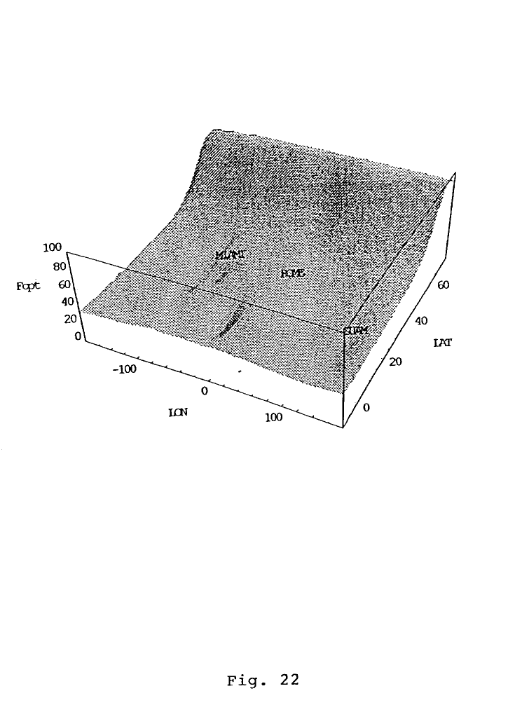

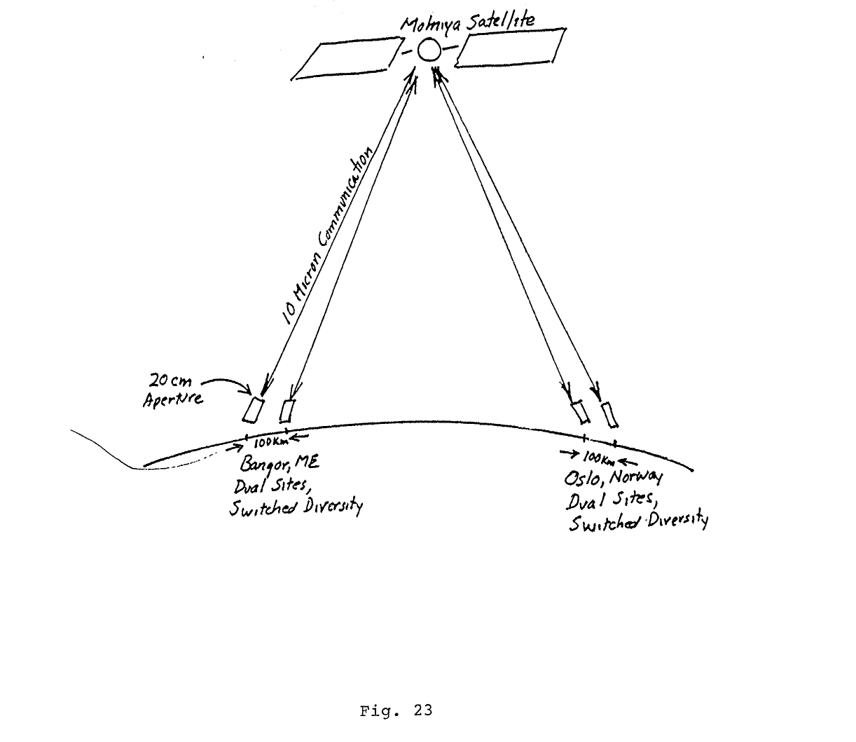

A preferred embodiment of the present invention utilizes a satellite system comprised of both satellites in geosynchronous orbits and elliptical Molniya orbits. One such preferred embodiment utilizes three satellites in Molniya orbits (as shown in FIG. 18) and two satellites in geosynchronous orbits (spaced even along the Equator), notes the resulting configuration shown in FIG. 20. This combination offers the lowest possible loss from atmospheric path length by offering optimal near-zenith communication paths. This preferred embodiment, utilizing the pdf equation shown above, yields the pdf for various ground station locations communicating with a satellite system comprised of three Molniya elliptical orbit satellites and two geosynchronous satellites, as shown in FIG. 21. The probability density function shown is calculated from satellite elevations over time at selected locations on the earth's surface. The elevation probability density function can be used to derive average cosecant of elevation for orbiting satellites of the present invention at various latitudes. This in turn can be applied to the prior results for attenuation at zenith to calculate attenuation, and thence the optimum frequencies for a given location. For example, using the equation shown in FIG. 19 and calculate pdf for a Molniya system of the present invention and applying the pdf results to prior determined zenith results yields a range of frequencies for the Molniya system, as shown in FIG. 22.

Because the orbits of the satellites of the present invention are not completely geosynchronous (i.e., the system also utilizes elliptical orbit Molniya satellites), the reception/transmission stations may be required to employ a tracking apparatus to fix communication between a fixed ground station and a moving (albeit slowly) satellite. These tracking apparatus to enable a continuous communication link are well known in the art and will not be described herein.

In addition, because of the elliptical nature of some of the satellites of the present invention, it is desirable to have the satellites of the present invention have a variable power consumption. In this configuration, the geosynchronous satellites must be capable of operations full time—that is, they must have enough power to operate during the entirety of their orbit. In contrast, the elliptical orbit satellites do not have constant power needs, as they are not used throughout their orbit. These satellites are instead only used during the apogee portions of their orbit; during the perigee portions they are not used and they do not need power to transmit and receive communications. Therefore, it is desirable to have at least the elliptical orbit satellites of the present invention become active—have enough power to transmit and receive communications—on portions of their apogee orbit.

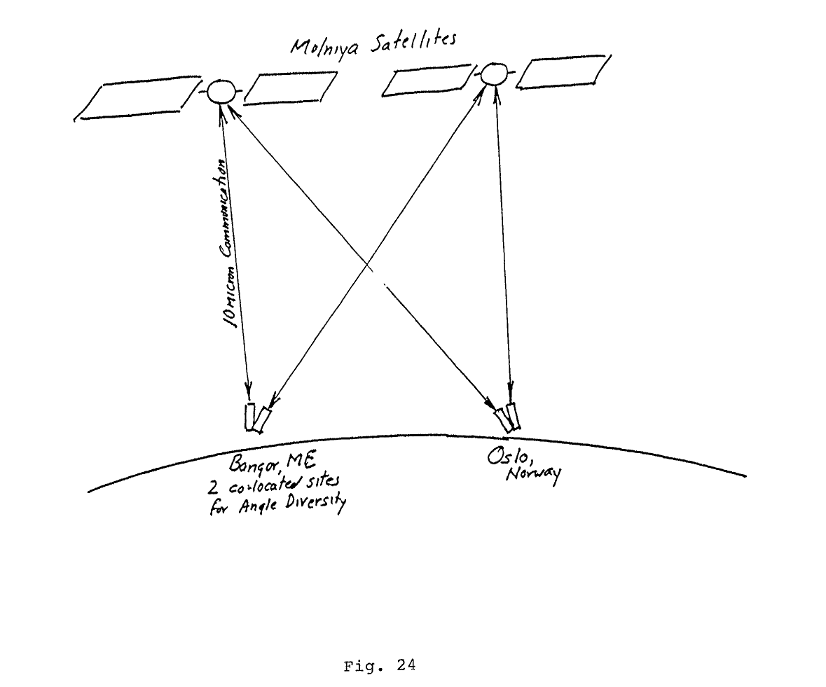

In another preferred embodiment, the present invention would be best deployed on long northerly routes for high data rate communication. FIG. 23 depicts a high data rate 10.6 micron wavelength link, typically greater than 100 Mb/s, from Bangor, Me. up to a satellite of the present invention and down to Oslo, Norway. Dual site diversity, with sites separated by 100 km, at both Bangor and Oslo is intended to raise link availability from 80% to 96%. (Quad diversity could raise link availability further, to 99.8%). The coherent 10.6 micron source would be a CO₂ laser or the type known in the art, or any other type of device capable of generating a communication wavelength in the desired range and known in the art, such as solid state lasers or tunable free electron lasers.

The link equation from Bangor to Molniya may be based on a typical range as 42E6 Megameters. With 20 cm apertures at Bangor, Molniya, and Oslo, the inputs to the link equation may be summarized as:

d,meters=0.2 r=42000000 λ=0.00001 Bandwidth=100000000 Hz

With the following assumptions, the uplink equation from Bangor to Molniya is:

$$EbN0a for 30 THz = \frac{{2.53276 }^{′} {10}^{7} {10}^{- adb / 10} {d}^{4} p t}{BT {λ}^{2}}$$

where EbN0a=Eb/N0 (10^{-adb/10}), to include cloud attenuation,

adb=20 dB cloud attenuation

B=bandwidth, Hz

T=5000 K, to include full sun effects in sidelobes

Note the link equation does not include quantum counting effects, as usually seen in optical links. The present invention offers the advantages where the photons at higher wavelengths have lower energy, and thus less quantum uncertainties, than those offered in the prior art. This is another advantage of 10 micron links over one micron links, where photons on 10 micron links are of lower energy and so numerous that quantum uncertainties are less critical. The link equation at 100 Mb/s and 1 bit/Hz yields:

EbN0=810.484 pt EbN0a=8.10484 pt

where EbN0a includes the 20 dB cloud attenuation, and pt is transmitted power in Watts. A choice of ½ rate encoding and Reed Solomon coding would allow a 10E−6 Bit Error Rate (BER) at approximately 5 dB EbN0a, or 3.16. Only 0.3901 Watts are indicated for pt, and doubling the required power to 0.78 Watts would allow 3 dB margin.

Another configuration of the present invention is shown on FIG. 24. Ten centimeter apertures are used to reduce costs for a 10 Mb/s link and angle diversity is used to reduce the cost of the 100 km land lines needed for site diversity. The 96% availability of FIG. 22 is reduced to the order of 90%, as angle diversity is not as effective as site diversity. The transmitted power is only 62% of the requirements for FIG. 22, or only 0.49 Watts are required to include 3 dB margin. In this embodiment, angle diversity and site diversity can also be combined for an effective system. For example, each of the two sites near Bangor, Maine may each have angle diversity to two different Molniya satellites. Each site would enjoy availability close to 90% with angle diversity. The combination of the two sites would allow total availability with switched diversity to approach 99%.

In another embodiment, the satellites of the present invention can be replaced by high altitude orbit aircraft (HALO aircraft) for effective use over different areas. As currently envisioned, HALO aircraft utilize 30 GHz communication frequencies; however, these systems may also utilize the infrared communications of the present invention.

While this invention has been described in reference to illustrative embodiments, the description is not intended to be construed in a limiting sense. Various modifications and combinations of the illustrative embodiments, as will as other embodiments of the invention, will be apparent to persons skilled in the art upon reference to the description. It is therefore intended that the appended claims encompass any of such modifications or embodiments.

[image]

[image]

[image]

[image]

[image]

[image]

[image]

[image]

[image]

[image]

[image]

[image]

[image]

[image]

[image]

I claim:

1. A satellite communication system comprising:
a terrestrial base station; and
a first satellite communicating with said terrestrial base station using a infrared signal.

2. The satellite communication system of claim 1, wherein said communicating includes transmitting said infrared signal between said terrestrial base station and said first satellite; and
wherein an optimal location for transmitting said infrared signal is determined based on a frequency of said infrared signal and the attenuation of said infrared signal at said frequency.

3. The satellite communication system of claim 2, wherein said attenuation is based on the cloud water content persistent in a region including said optimal location.

4. The satellite communication system of claim 3, wherein said optimal location is defined by longitude and latitude.

5. The satellite communication system of claim 3, wherein said cloud water content is determined based on an exceedance probability.

6. The satellite communication system of claim 3, wherein said cloud water content is determined based on a cloud water content formula.

7. The satellite communication system of claim 3, wherein said optimal location is based on the probability density function of an elevation angle.

8. The satellite communication system of claim 1, further comprising at least a second satellite, a third satellite, a fourth satellite, and a fifth satellite, said first satellite, said second satellite, and said third satellite each being in a phased Molniya orbit, and said fourth satellite and said fifth satellite each being in a geosynchronous orbit.

9. The satellite communication system of claim 1, wherein said communicating includes receiving said infrared signal between said terrestrial base station and said first satellite; and
wherein an optimal location for receiving said infrared signal is determined based on a frequency of said infrared signal and the attenuation of said infrared signal at said frequency.

10. The satellite communication system of claim 9, wherein said attenuation is based on the cloud water content persistent in a region including said optimal location.

11. The satellite communication system of claim 10, wherein said optimal location is defined by longitude and latitude.

12. The satellite communication system of claim 10, wherein said cloud water content is determined based on an exceedance probability.

13. The satellite communication system of claim 10, wherein said cloud water content is determined based on a cloud water content formula.

14. The satellite communication system of claim 10, wherein said optimal location is based on the probability density function of an elevation angle.

15. A terrestrial base station communication system comprising:
a terrestrial base station communicating with a first satellite using an infrared signal.

16. The terrestrial base station communication system of claim 15, wherein said communicating includes transmitting said infrared signal between said terrestrial base station and said first satellite; and
wherein an optimal location for transmitting said infrared signal is determined based on a frequency of said infrared signal and the attenuation of said infrared signal at said frequency.

17. The terrestrial base station communication system of claim 16, wherein said attenuation is based on the cloud water content persistent in a region including said optimal location.

18. The terrestrial base station communication system of claim 17, wherein said optimal location is defined by longitude and latitude.

19. The terrestrial base station communication system of claim 17, wherein said cloud water content is determined based on an exceedance probability.

20. The terrestrial base station communication system of claim 17, wherein said cloud water content is determined based on a cloud water content formula.

21. The terrestrial base station communication system of claim 17, wherein said optimal location is based on the probability density function of an elevation angle.

22. The terrestrial base station communication system of claim 15, further comprising at least a second satellite, a third satellite, a fourth satellite, and a fifth satellite, said first satellite, said second satellite, and said third satellite each being in a phased Molniya orbit, and said fourth satellite and said fifth satellite each being in a geosynchronous orbit.

23. The terrestrial base station communication system of claim 15, wherein said communicating includes receiving said infrared signal between said terrestrial base station and said first satellite; and
wherein an optimal location for receiving said infrared signal is determined based on a frequency of said infrared signal and the attenuation of said infrared signal at said frequency.

24. The terrestrial base station communication system of claim 23, wherein said attenuation is based on the cloud water content persistent in a region including said optimal location.

25. The terrestrial base station communication system of claim 24, wherein said optimal location is defined by longitude and latitude.

26. The terrestrial base station communication system of claim 24, wherein said cloud water content is determined based on an exceedance probability.

27. The terrestrial base station communication system of claim 24, wherein said cloud water content is determined based on a cloud water content formula.

28. The terrestrial base station communication system of claim 24, wherein said optimal location is based on the probability density function of an elevation angle.

29. A method for determining an optimal location for transmitting an infrared signal between a terrestrial base station and a satellite, said method comprising the steps of:
determining a first cloud water content at a first location in a region;
determining a first attenuation of said infrared signal based on said first cloud water content;
determining a second cloud water content at a second location in said region;
determining a second attenuation of said infrared signal based on said second cloud water content;
determining the lesser of said first attenuation and said second attenuation;
selecting one of said first location and said second location as an optimal location, said first location being selected if said first attenuation is less than said second attenuation, said second location being selected if said second attenuation is less than said first attenuation.

30. The method of claim 29, wherein said step of determining said first cloud water content is based on an exceedance probability.

31. The method of claim 29, wherein said step of determining said second cloud water content is based on an exceedance probability.

32. The method of claim 29, wherein both said step of determining said first cloud water content and said step of determining said second water content is based on an exceedance probability.

33. The method of claim 29, wherein said step of determining said first cloud water content is based on an exceedance probability.

34. The method of claim 29, wherein said step of determining said second cloud water content is based on an exceedance probability.

35. The method of claim 29, wherein both said step of determining said first cloud water content and said step of determining said second water content is based on an exceedance probability.

36. The method of claim 29, wherein said step of determining said first attenuation is based on the probability density function of an elevation angle.

37. The method of claim 29, wherein said step of determining said second attenuation is based on the probability density function of an elevation angle.

38. The method of claim 29, wherein both said step of determining said first attenuation and said step of determining said second attenuation is based on the probability density function of an elevation angle.

39. A method for determining an optimal location for receiving an infrared signal between a terrestrial base station and a satellite, said method comprising the steps of:
determining a first cloud water content at a first location in a region;
determining a first attenuation of said infrared signal based on said first cloud water content;
determining a second cloud water content at a second location in said region;
determining a second attenuation of said infrared signal based on said second cloud water content;
determining the lesser of said first attenuation and said second attenuation;
selecting one of said first location and said second location as an optimal location, said first location being selected if said first attenuation is less than said second attenuation, said second location being selected if said second attenuation is less than said first attenuation.

40. The method of claim 39, wherein said step of determining said first cloud water content is based on an exceedance probability.

41. The method of claim 39, wherein said step of determining said second cloud water content is based on an exceedance probability.

42. The method of claim 39, wherein both said step of determining said first cloud water content and said step of determining said second water content is based on an exceedance probability.

43. The method of claim 39, wherein said step of determining said first cloud water content is based on an exceedance probability.

44. The method of claim 39, wherein said step of determining said second cloud water content is based on an exceedance probability.

45. The method of claim 39, wherein both said step of determining said first cloud water content and said step of determining said second water content is based on an exceedance probability.

46. The method of claim 39, wherein said step of determining said first attenuation is based on the probability density function of an elevation angle.

47. The method of claim 39, wherein said step of determining said second attenuation is based on the probability density function of an elevation angle.

48. The method of claim 39, wherein both said step of determining said first attenuation and said step of determining said second attenuation is based on the probability density function of an elevation angle.

49. A satellite communication system comprising:
a terrestrial base station;
a first satellite communicating with said terrestrial base station using a signal;
wherein said communicating includes transmitting said signal between said terrestrial base station and said first satellite;
wherein an optimal location for transmitting said signal is determined based on a frequency of said signal and the attenuation of said signal at said frequency; and
wherein said attenuation is based on the cloud water content persistent in a region including said optimal location.

50. A satellite communication system comprising:
a terrestrial base station;
a first satellite communicating with said terrestrial base station using a signal;
wherein said communicating includes receiving said signal between said terrestrial base station and said first satellite;
wherein an optimal location for transmitting said signal is determined based on a frequency of said signal and the attenuation of said signal at said frequency; and
wherein said attenuation is based on the cloud water content persistent in a region including said optimal location.

51. The satellite communication system of claim 50, wherein the terrestrial base station is located at the optimal location.
